(19) United States
(12) Patent Application Publication
(10) Pub. No.: US 2012/0105682 A1
(43) Pub. Date: May 3, 2012

(54) IMAGE PICKUP APPARATUS GENERATING COMPOSITE IMAGE

(75) Inventors: Kazuaki Hata, Daito-shi (JP); Yurie Sakai, Osaka-shi (JP)

(73) Assignee: SANYO ELECTRIC CO., LTD., Osaka (JP)

(21) Appl. No.: 13/283,085

(22) Filed: Oct. 27, 2011

(30) Foreign Application Priority Data
Oct. 29, 2010 (JP) 2010-243995

(51) Int. Cl. H04N 5/262

(52) U.S. Cl. 348/239; 348/E05.051

(57) ABSTRACT

Provided is an image pickup apparatus wherein an image pickup unit executes image pickup processing a plurality of times in relation to movement of the image pickup surface to generate a composite image. In the image pickup apparatus, first information for guiding a direction in which the image pickup surface should be moved and second information for indicating the direction and amount that the image pickup surface has been moved during processing for generating a composite image are displayed on a display unit.

This nonprovisional application is based on Japanese Patent Application No. 2010-243995 filed on Oct. 29, 2010 with the Japan Patent Office, the entire contents of which are hereby incorporated by reference.

### BACKGROUND OF THE INVENTION

1. Field of the Invention

The present invention relates to an image pickup apparatus, and more particularly to an image pickup apparatus generating a composite image.

2. Description of the Related Art

Conventionally, in relation to an image pickup apparatus, there is a technique for joining a plurality of divided images obtained by image pickup with a large field of view divided within a range of angle of coverage of the image pickup apparatus, thereby generating a so-called composite image.

In an example of such a technique, a composite image is generated by joining an image picked up at a certain point of time to images having been picked up so far. With this technique, upon receipt of selection of reproduced images for use in generation of a composite image and then upon receipt of designation of a direction in which a picked up image (an image being picked up at that point of time) is to be joined to reproduced images (images having been picked up so far), the image pickup apparatus causes a finder to display an edge of the reproduced images. A person picking up images picks up an image in alignment with that edge. Then, the image pickup apparatus reproduces a composite image generated by joining the picked up image to the reproduced images in the designated direction.

When a user picks up a plurality of divided images successively using an image pickup apparatus as described above, he/she is required to determine whether or not the image pickup surface of the camera is moving without being displaced from the direction displayed as described above, based on an image displayed on the camera finder.

### SUMMARY OF THE INVENTION

An image pickup apparatus according to an aspect of the present invention includes an image pickup unit having an image pickup surface on which an optical image of a subject is imaged, for executing image pickup processing which generates a frame image based on the optical image; and a control unit which controls the image pickup unit to execute the image pickup processing repeatedly to cause a display unit to display frame images generated sequentially. The control unit executes composite image generation processing which generates a composite image by combining part or whole of each of a plurality of frame images generated when the image pickup unit executes the image pickup processing a plurality of times in relation to movement of the image pickup surface, and causes the display unit to display first information which guides a direction in which the image pickup surface should be moved during the composite image generation processing and second information which indicates a direction and an amount that the image pickup surface has been moved.

A method of controlling an image pickup apparatus according to another aspect of the present invention is a method of controlling an image pickup apparatus having an image pickup surface on which an optical image of a subject is imaged. The method includes the steps of executing image pickup processing which generates a frame image based on the optical image on the image pickup surface, executing composite image generation processing which generates a composite image by combining part or whole of each of a plurality of frame images generated by execution of the image pickup processing a plurality of times in relation to movement of the image pickup surface, and causing a display unit to display first information which guides a direction in which the image pickup surface should be moved during the composite image generation processing and second information which indicates a direction and an amount that the image pickup surface has been moved.

An image pickup apparatus according to still another aspect of the present invention includes an image pickup unit having an image pickup surface on which an optical image of a subject is imaged, for executing image pickup processing which generates a frame image based on the optical image, and a control unit which controls the image pickup unit to execute the image pickup processing repeatedly to cause a display unit to display frame images generated sequentially. The control unit executes composite image generation processing which generates a composite image by combining part or whole of each of a plurality of frame images generated when the image pickup unit executes the image pickup processing a plurality of times in relation to movement of the image pickup surface, and causes the display unit to display information which indicates a displacement of a position where the image pickup surface has been moved from a position where the image pickup surface should be moved during the composite image generation processing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are outline perspective views of a digital camera as an example of an image pickup apparatus as an embodiment of the present invention.

FIG. 2 schematically shows a hardware configuration of the digital camera shown in FIG. 1.

FIGS. 3 to 11 each show an example of screen displayed on the digital camera shown in FIG. 1.

FIG. 12 is a flow chart of a main routine executed in the digital camera shown in

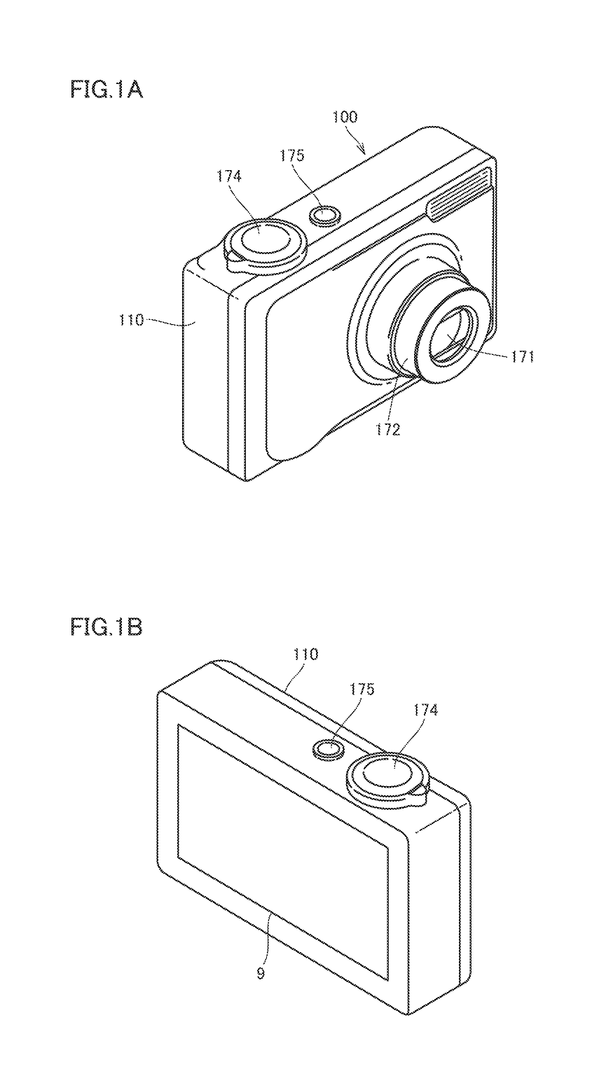

FIG. 1.

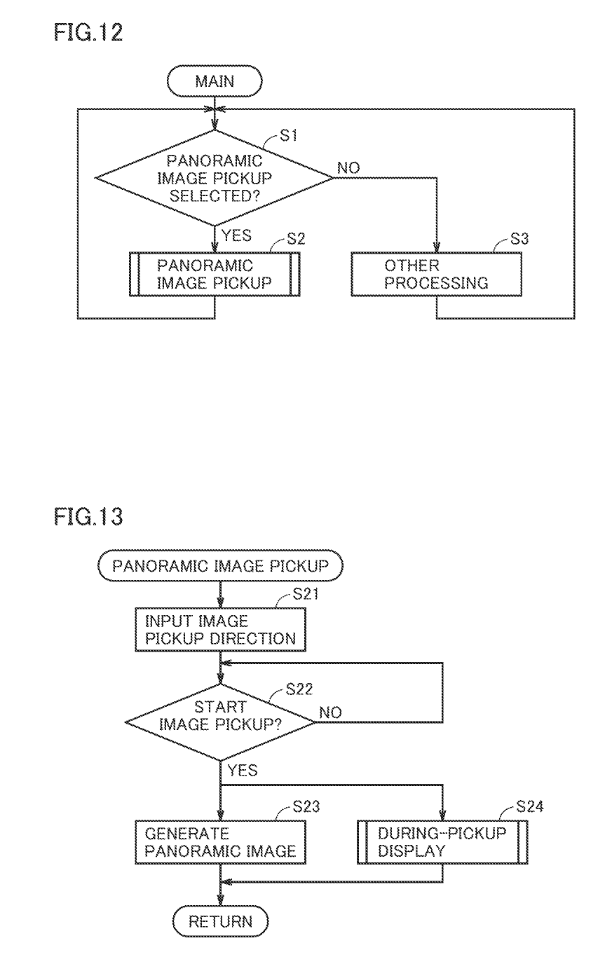

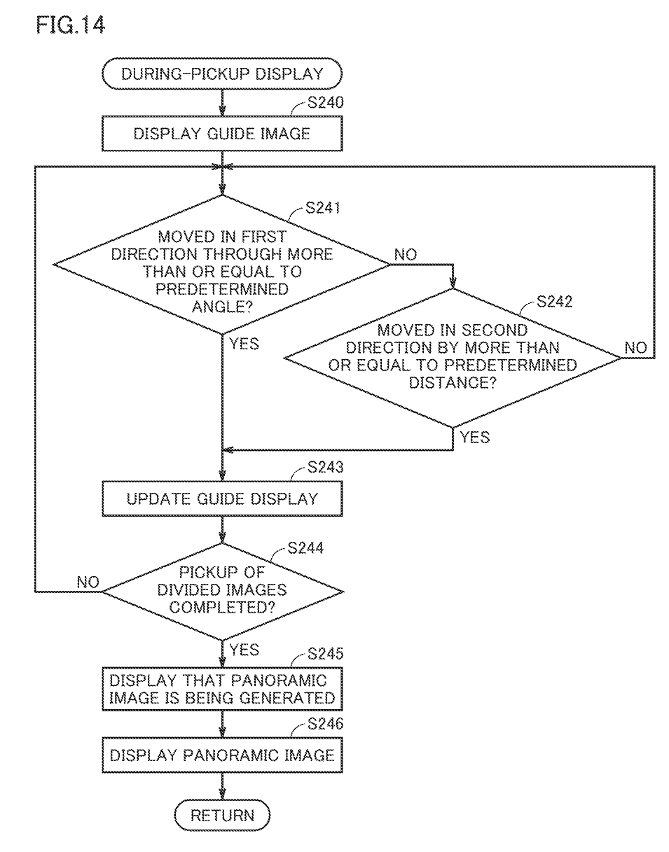

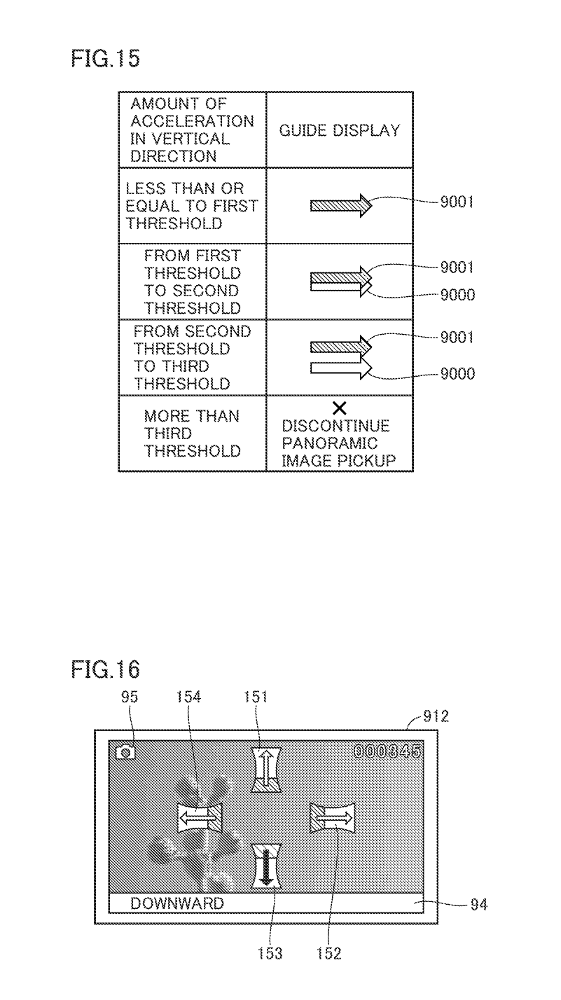

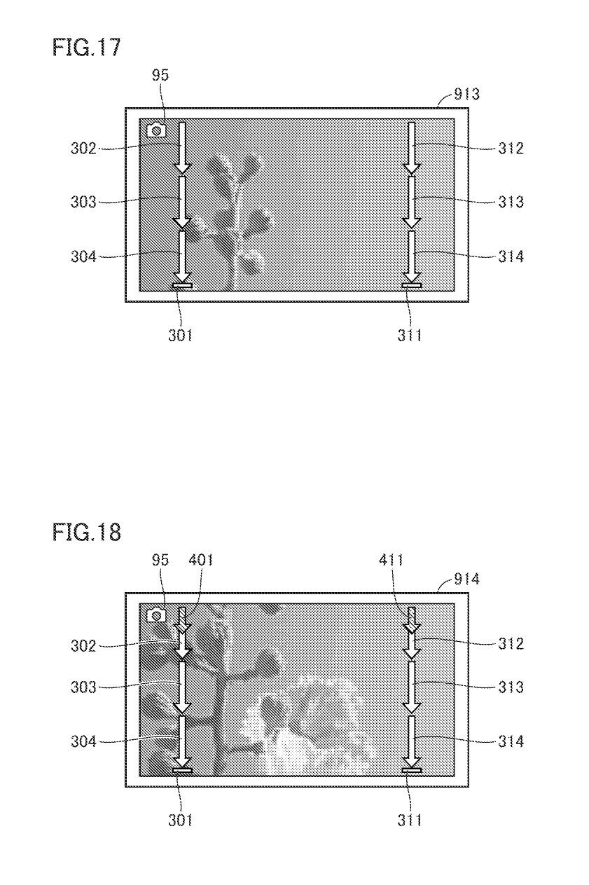

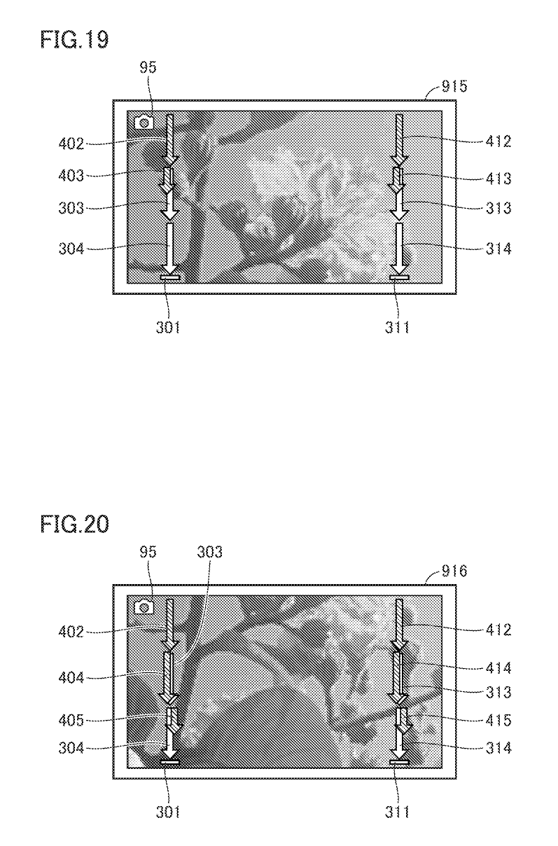

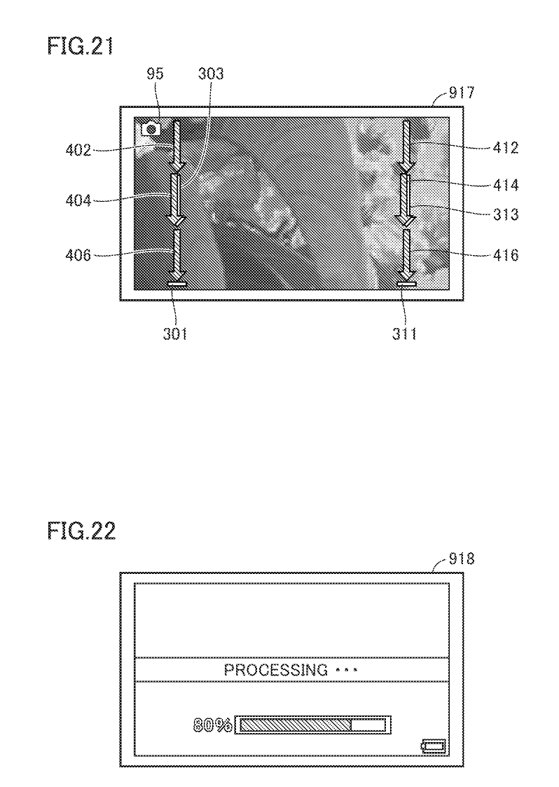

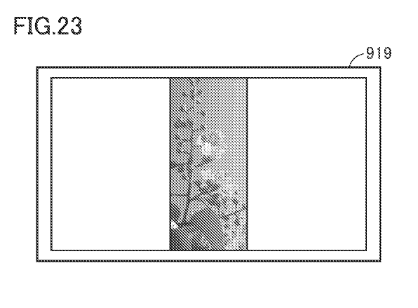

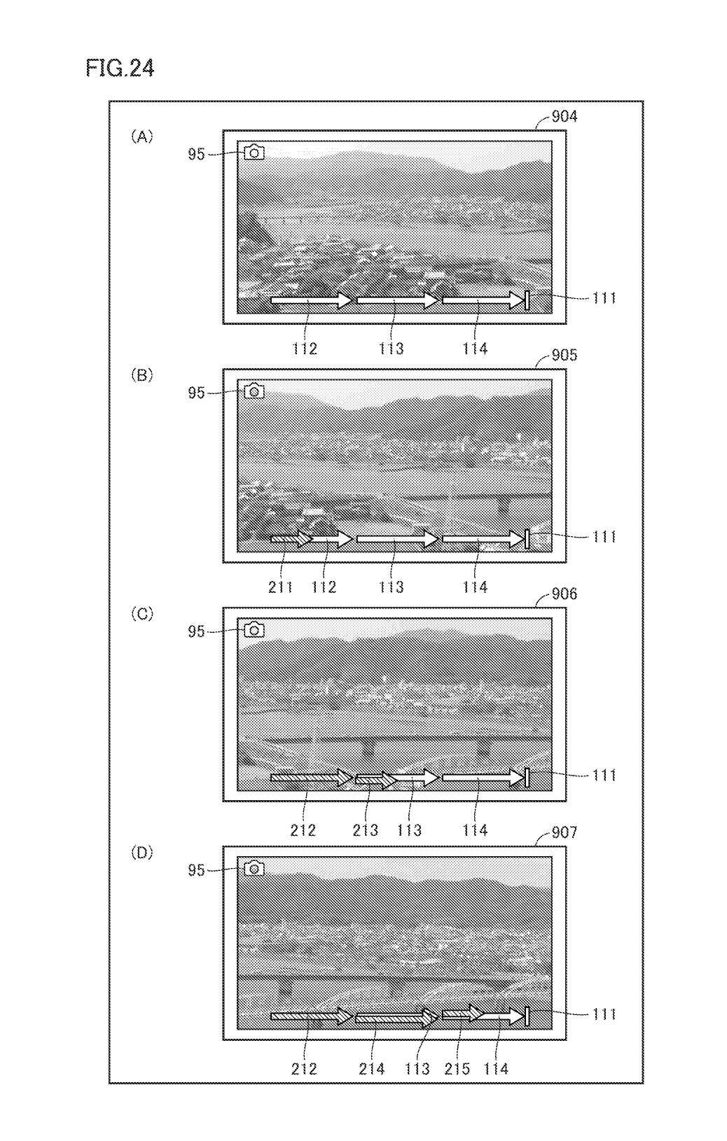

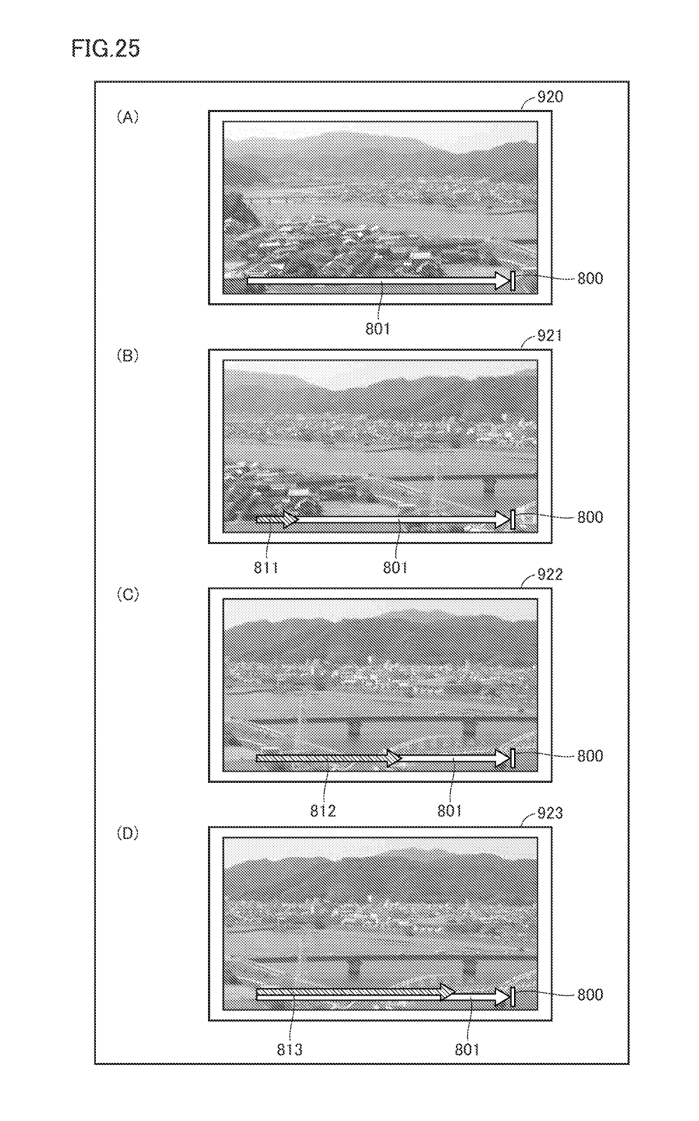

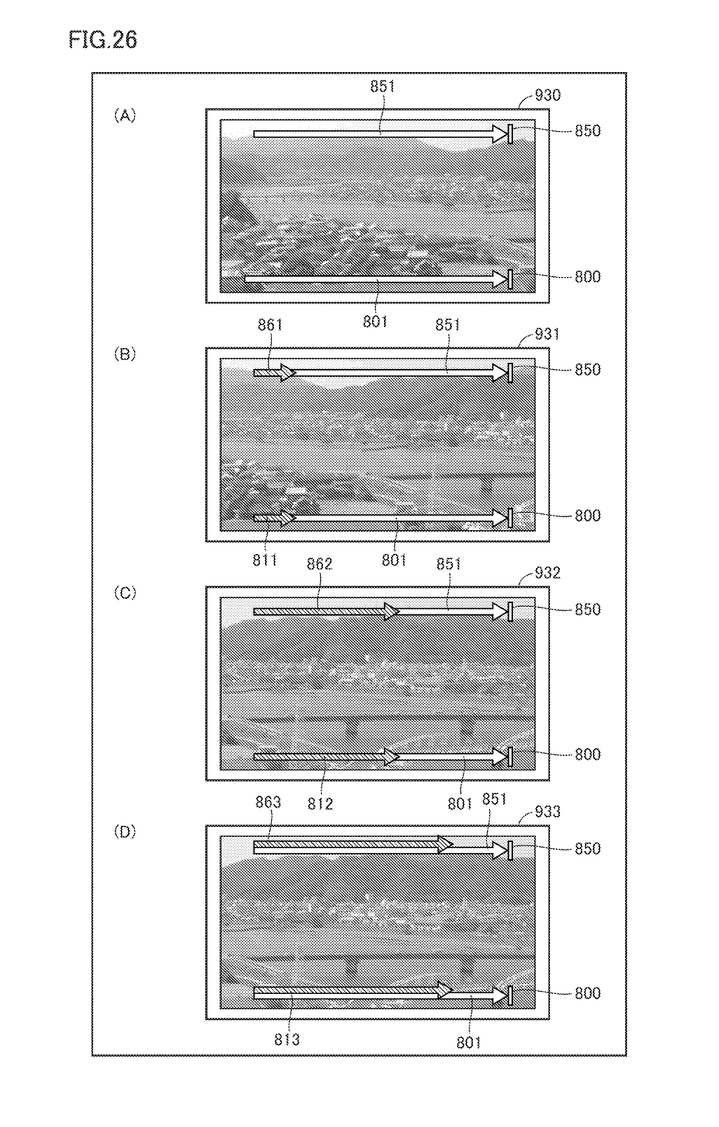

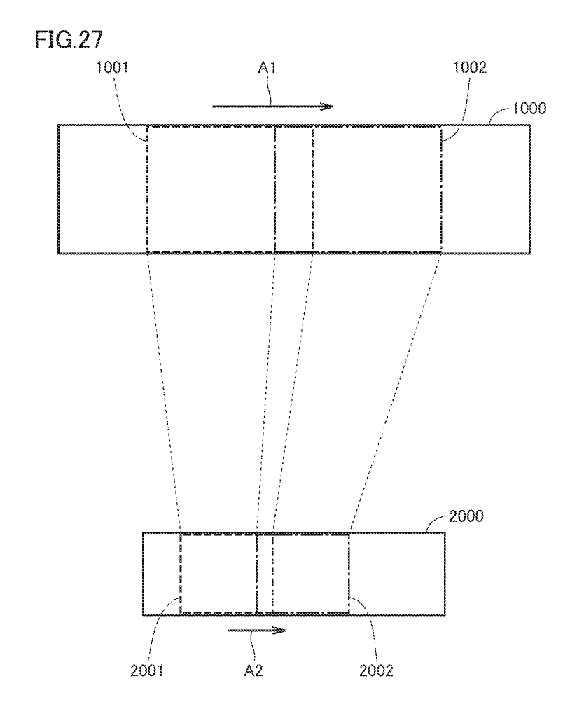

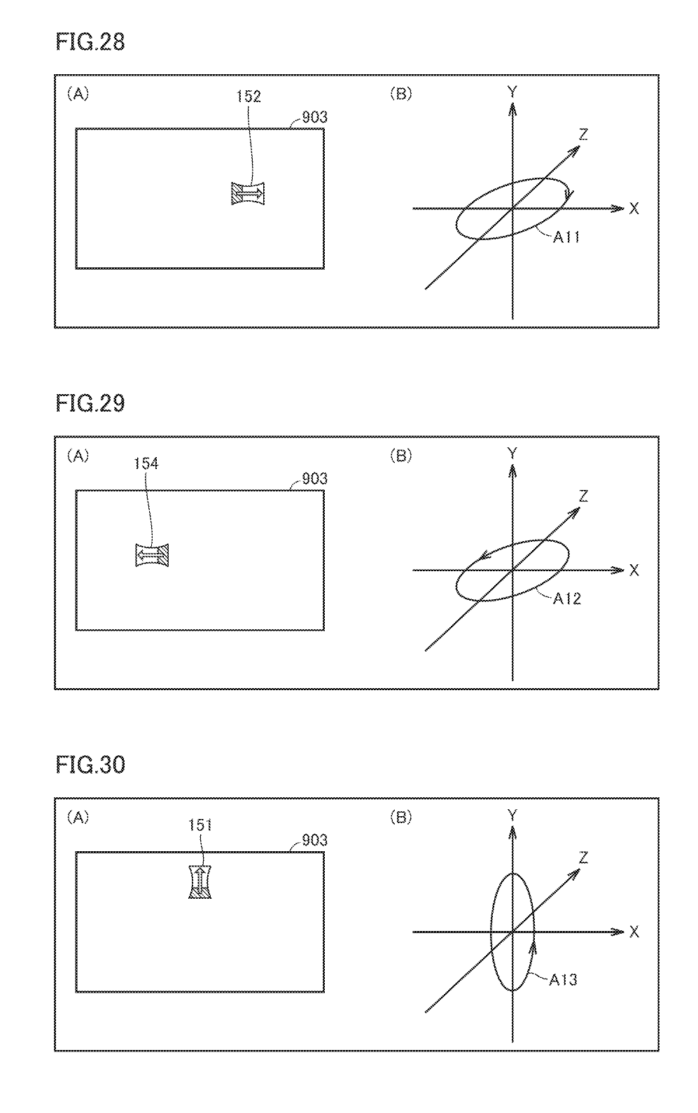

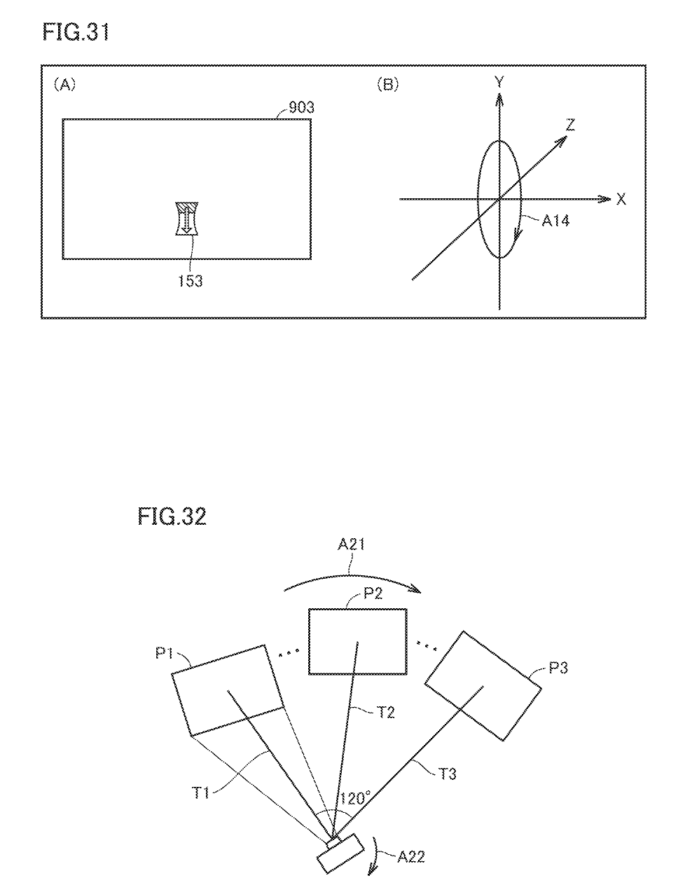

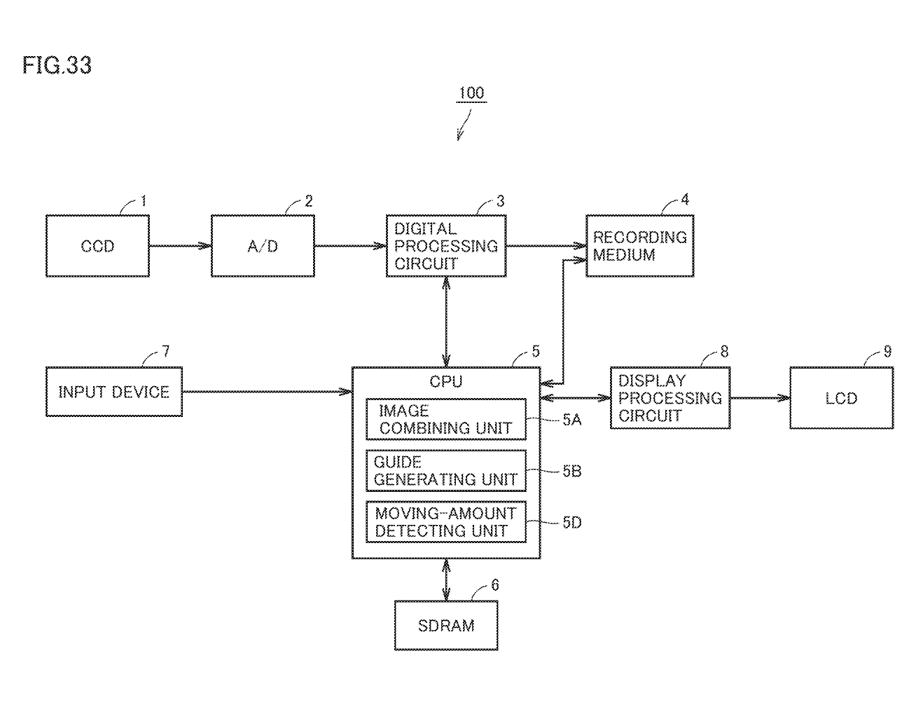

FIG. 13 is a flow chart of a subroutine of step S2 shown in FIG. 12.

FIG. 14 is a flow chart of a subroutine of step S24 shown in FIG. 13.

FIG. 15 schematically shows the relationship between display of trajectory and moving distance of a main body in a second direction, in the digital camera shown in FIG. 1.

FIGS. 16 to 26 each show another example of screen displayed on the digital camera shown in FIG. 1.

FIG. 27 schematically shows the relationship between a panoramic image generated in the digital camera shown in FIG. 1 and divided images used for generating the panoramic image.

FIGS. 28 to 30 are explanatory views of examples of relationship between image pickup direction and a first direction in the digital camera shown in FIG. 1.

FIG. 31 shows still another example of screen displayed on the digital camera shown in FIG. 1.

FIG. 32 is an explanatory view of a turning angle of the main body in panoramic image pickup of the digital camera shown in FIG. 1.

FIG. 33 schematically shows a hardware configuration of a variation of the digital camera shown in FIG. 1.

### DESCRIPTION OF THE PREFERRED EMBODIMENTS

Hereinafter, an embodiment of the present invention will be described in detail with reference to the drawings. It is noted that identical or corresponding parts in the drawings are denoted by identical reference characters, and repeated description thereof will not be repeated.

[1. Configuration of Digital Camera]

FIGS. 1A and 1B are outline perspective views of a digital camera 100 as an example of an image pickup apparatus as an embodiment of the present invention.

In addition, the present embodiment will describe a panoramic image as an example of a composite image.

Referring to FIG. 1A, digital camera 100 includes a main body 110. Main body 110 has, on its front, a lens tube 172 with an image pickup lens 171 incorporated therein. Lens tube 172 is a collapsible lens tube, and has a movable lens tube that is retracted inside. When a user turns on a power button 175, the movable lens tube is pulled out from main body 110 by a drive motor to an image pickup position shown in FIG. 1A. When power button 175 is turned off in this state, the movable lens tube is retracted into main body 110 by the drive motor to assume a so-called collapsible state.

Provided on the upper surface of main body 110 are power button 175 for turning on/off power to digital camera 100 and a release button 174 for entering an instruction, such as start of image pickup, to digital camera 100.

FIG. 1B shows the rear surface of main body 110 shown in FIG. 1A. An LCD (Liquid Crystal Display) 9 is provided on the rear surface.

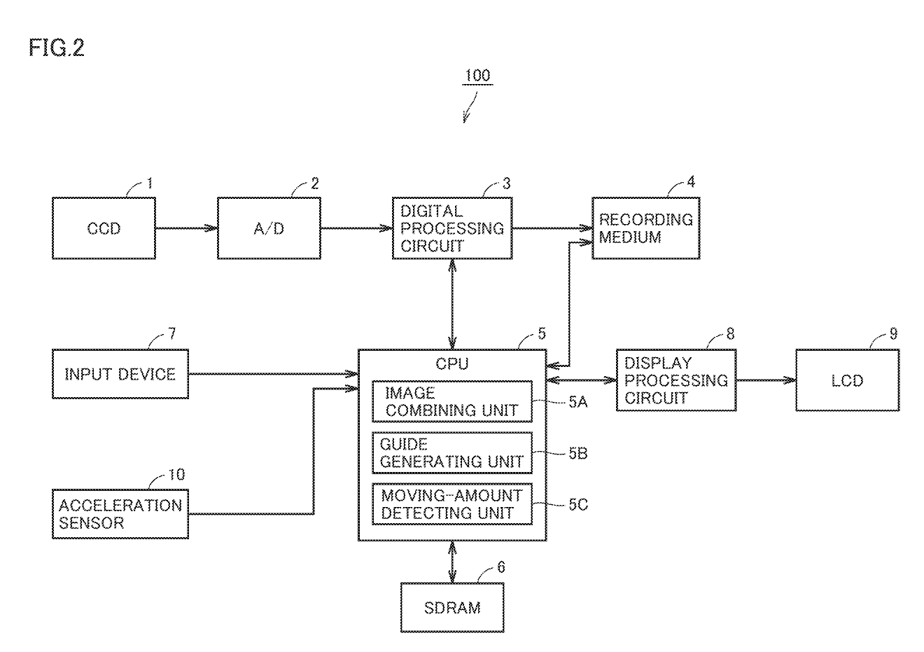

FIG. 2 schematically shows a hardware configuration of digital camera 100 shown in FIG. 1.

Referring to FIG. 2, digital camera 100 includes a CCD 1 (Charge Coupled Device) as an example of an image pickup unit, an A/D (Analog/Digital) conversion processing circuit 2 converting an analog image signal obtained from CCD 1 into digital image data, a digital processing circuit 3 executing image processing, such as resolution conversion processing and compression processing, and a recording medium 4 for recording image data obtained by image pickup. A CPU 5 is connected to digital processing circuit 3 and recording medium 4.

Recording medium 4 can be implemented by a recording medium that is fixed to digital camera 100 or that is removable therefrom, including a CD-R (Compact Disc-Rewritable), a DVD-R (Digital Versatile Disc-Rewritable), a flash memory, a USB (Universal Serial Bus) memory, a memory card, an FD (Flexible Disc), a hard disc, a magnetic tape, a cassette tape, an MO (Magnetic Optical Disc), an MD (Mini Disc), an IC (Integrated Circuit) card (excluding memory cards), an optical card, a mask ROM, an EPROM, and an EEPROM (Electronically Erasable Programmable Read-Only Memory).

An SDRAM (Synchronous Dynamic Random Access Memory) that CPU 5 uses during image processing is connected to CPU 5. An input device 7 is also connected to CPU 5. Input device 7 includes power button 175 and release button 174 described above. It is noted that input device 7 may include a touch sensor provided over LCD 9. That is, input device 7 and LCD 9 may constitute a touch panel. LCD 9 for displaying an image obtained by image pickup is also connected to CPU 5 with a display processing circuit 8 executing predetermined image display processing interposed therebetween.

An acceleration sensor 10 measuring the acceleration applied to main body 110 of digital camera 100 is also connected to CPU 5. In digital camera 100, CCD 1 generates an image of a range introduced through an optical system including image pickup lens 171. The optical system is fixed to main body 110 of digital camera 100. CCD 1 can thereby detect the moving direction of the image pickup surface of CCD 1 based on the acceleration detected by acceleration sensor 10. CPU 5 can detect in which direction and by which amount the above-described image pickup surface has been moved, based on the direction in which the image pickup surface has been moved and the length of time when image pickup surface has been moved in that direction. CPU 5 includes an image combining unit 5A, a guide generating unit 5B and a moving-amount detecting unit 5C as its functions. These functions may be performed by CPU 5 executing a program stored in recording medium 4 or the like, or may be performed as hardware by a dedicated circuit (ASIC (Application Specific Integrated Circuit, etc) in digital camera 100.

Image combining unit 5A generates a panoramic image by joining a plurality of divided images (each being an image of one frame picked up by CCD 1 (a frame image)). As the technique for joining a plurality of divided images to generate a panoramic image, a publicly-known technique can be adopted. The publicly-known technique includes a technique disclosed in Japanese Patent No. 3545297, for example. According to the technique disclosed in that publication, a plurality of images can be combined to generate a combined image for 360 degrees projected on a cylindrical surface. It is noted that, when the technique disclosed in that publication is adopted in the present embodiment, an image generated as a combined image is not limited to an image with a projection angle of 360 degrees, but it is intended that the angle is changed as appropriate. Guide generating unit 5B generates guide information indicative of the direction in which the image pickup surface of CCD 1 should be moved and the like when a plurality of divided images are successively picked up by digital camera 100. Moving-amount detecting unit 5C detects the direction and amount of movement of main body 110 of digital camera 100, based on a detection output of acceleration sensor 10.

[2. Movement of Main Body and Detection Output of Acceleration Sensor in Panoramic Image Pickup]

FIG. 27 schematically shows the relationship between a panoramic image generated in digital camera 100 and divided images used for generating the panoramic image.

Referring to FIG. 27, in digital camera 100, a plurality of divided images including divided images 2001, 2002 are joined to generate a panoramic image 2000. Divided image 2001 is indicated by dashed lines, and divided image 2002 is indicated by alternate long and short dashed lines. In FIG. 27, an arrow A2 indicates the order in which a panoramic image is picked up and the direction in which a plurality of divided images are joined when panoramic image 2000 is generated. That is, divided image 2002 is an image picked up upon pickup of divided image 2001. In panoramic image 2000, divided image 2002 is joined to divided image 2001 along arrow A2.

Panoramic image 2000 corresponds to a region 1000 in the real world. Divided image 2001 corresponds to a region 1001 in region 1000, and divided image 2002 corresponds to a region 1002 in region 1000.

In digital camera 100, a panoramic image pickup menu is executed as a menu for generating a panoramic image. In the panoramic image pickup menu, main body 110 is turned so that a plurality of divided images including divided images 2001, 2002 are successively picked up. In the present specification, an operation of the digital camera when the panoramic image pickup menu is executed will be called “panoramic image pickup.” Panoramic image pickup includes pickup of a plurality of divided images and generation of a panoramic image based on them. An arrow A1 is equivalent to the direction of arrangement of the regions in the real world in correspondence with the arrangement of images indicated by arrow A2. In panoramic image pickup for generating panoramic image 2000 shown in FIG. 27, the image pickup surface of CCD 1 is moved along arrow A1.

Acceleration sensor 10 can detect the acceleration along three axes. In digital camera 100, CPU 5 can specify the direction and amount that main body 110 has been moved based on a detection output of acceleration sensor 10 during panoramic image pickup.

In panoramic image pickup, designation of the direction in which divided images picked up successively are to be joined (hereinafter referred to as “image pickup direction”) is accepted. CPU 5 specifies the direction in which main body 110 should be moved (hereinafter referred to as “first direction”) in accordance with the designated direction. The first direction represents the direction of turning as will be described later. In panoramic image pickup, CPU 5 detects the angle by which main body 110 has been moved in the first direction, and when a predetermined angle is detected, terminates pickup of divided images in panoramic image pickup.

CPU 5 causes LCD 9 to display information (first information) indicative of the first direction.

Further, when main body 110 is moved in the direction perpendicular to the first direction (hereinafter referred to as “second direction”) in panoramic image pickup, CPU 5 causes LCD 9 to display information (second information) indicative of that perpendicular direction.

In the present specification, the first information and the second information will be collectively referred to as a guide display.

A specific example of the relationship among the image pickup direction, the first direction and the second direction will now be described.

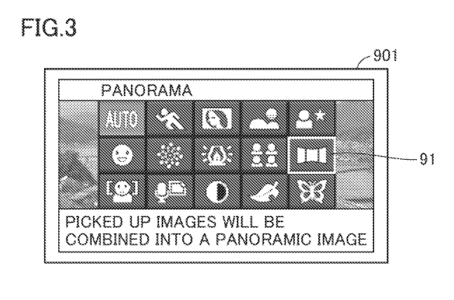

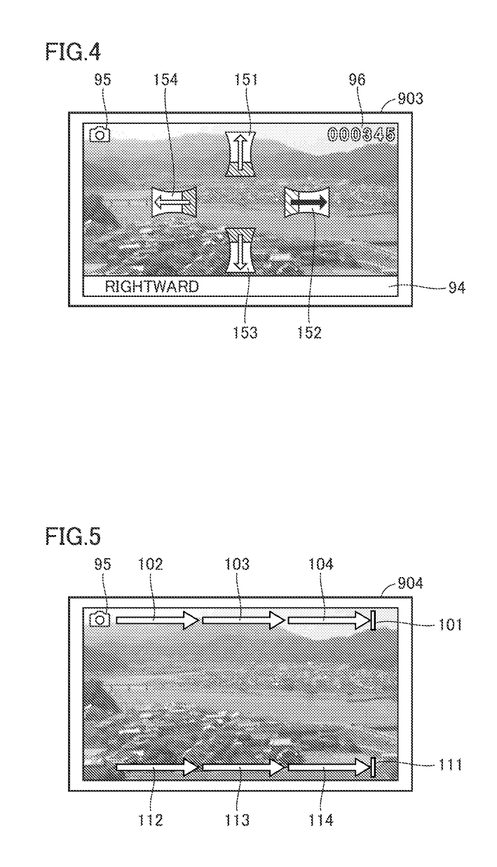

In digital camera 100, as will be described later, a menu screen 901 shown in FIG. 3 is displayed on LCD 9. When a button 91 is selected on menu screen 901, the panoramic image pickup menu is executed. In the panoramic image pickup menu, a screen 903 shown in FIG. 4 is displayed on LCD 9. Screen 903 includes buttons 151, 152, 153, and 154. When button 151 is selected, “upward” is selected as the image pickup direction. When button 152 is selected, “rightward” is selected as the image pickup direction. When button 153 is selected, “downward” is selected as the image pickup direction. When button 154 is selected, “leftward” is selected as the image pickup direction.

FIGS. 28 to 30 schematically show the relationship between the image pickup direction and the first direction. Each figure shows at (A) a button selected from among the buttons displayed on screen 903, and shows at (B) three axes (X-axis, Y-axis and Z-axis) along which acceleration sensor 10 detects the acceleration.

When button 152 is selected on screen 903 as shown in FIG. 28 at (A) to designate “rightward” as the image pickup direction, the specific direction will be the turning direction indicated by an arrow A11 in FIG. 28 at (B). The turning direction indicated by arrow A11 is a direction of turning clockwise in the X-Z plane.

When button 154 is selected on screen 903 as shown in FIG. 29 at (A) to designate “leftward” as the image pickup direction, the specific direction will be the turning direction indicated by an arrow A12 in FIG. 29 at (B). The turning direction indicated by arrow A12 is a direction of turning counterclockwise in the X-Z plane.

When button 151 is selected on screen 903 as shown in FIG. 30 at (A) to designate “upward” as the image pickup direction, the specific direction will be the turning direction indicated by an arrow A13 in FIG. 30 at (B). The turning direction indicated by arrow A13 is a direction of turning counterclockwise in the Y-Z plane.

When button 153 is selected on screen 903 as shown in FIG. 31 at (A) to designate “downward” as the image pickup direction, the specific direction will be the turning direction indicated by an arrow A14 in FIG. 31 at (B). The turning direction indicated by arrow A14 is a direction of turning clockwise in the Y-Z plane.

[3. Main Routine]

Processing executed in digital camera 100 will now be described in detail.

FIG. 12 is a flow chart of a main routine executed by CPU 5 of digital camera 100.

Referring to FIG. 12, when power to digital camera 100 is turned on, CPU 5 determines at step S1 whether or not the panoramic image pickup menu has been selected. If determined that the menu has been selected, the process is advanced to step S2, and if determined that another operation has been made, the process is advanced to step S3.

At step S2, CPU 5 executes panoramic image pickup processing, and returns process to step S1. Panoramic image pickup processing is processing for causing digital camera 100 to execute panoramic image pickup. At step S3, CPU 5 executes processing corresponding to an operation made to input device 7 or the like, and returns process to step S1.

CPU 5 causes LCD 9 to display a menu screen (screen 903) as shown in FIG. 3 at power-on, or upon completion of processing related to default setting after power-on or when a predetermined operation is made on input device 7. Menu screen 901 includes a plurality of buttons including button 91 for selecting the panoramic image pickup menu. When, for example, the operation of selecting button 91 is made on input device 7, CPU 5 determines that the panoramic image pickup menu has been selected.

[4. Panoramic Image Pickup Processing]

FIG. 13 is a flow chart of a subroutine of step S2 shown in FIG. 12.

Referring to FIG. 13, in panoramic image pickup processing, CPU 5 at step S21 first receives entry of information that selects the direction (image pickup direction) in which the image pickup surface of CCD 1 is to be moved in the panoramic image pickup menu. For example, as described above, CPU 5 causes LCD 9 to display screen 903 shown in FIG. 4, and receives entry of information that selects from among buttons 151 to 154.

Screen 903 shown in FIG. 4 displays buttons 151 to 154 together with an image that CCD 1 is picking up. Screen 903 further includes a pictorial image 95 and a number-of-picked-up-images display 96. Pictorial image 95 is an image indicating that what is displayed on LCD 9 is an image picked up by CCD 1.

Number-of-picked-up-images display 96 indicates the number of images stored in recording medium 4. CPU 5 causes LCD 9 to display pictorial image 95 and number-of-picked-up-images display 96 with a publicly-known technique. CPU 5 causes LCD 9 also to display a selected image pickup direction in a display box 94.

Referring again to FIG. 13, upon receipt of entry of information that designates the image pickup direction at step S21, CPU 5 advances the process to step S22.

At step S22, CPU 5 determines whether or not an instruction to start panoramic image pickup has been entered by operation of release button 174 or the like, and if determined that the instruction has been entered, advances the process to steps S23 and S24. CPU 5 performs steps S23 and S24 in parallel.

CPU 5 at step S23 executes panoramic image generation processing. The panoramic image generation processing includes generation of a plurality of divided images using CCD 1 and generation of a panoramic image by joining the plurality of divided images. CPU 5 at step S24 executes during-pickup display processing. In during-pickup display processing in panoramic image pickup processing, a guide display as described above is provided on LCD 9 together with an image picked up by CCD 1. During-pickup display processing at step S24 will be described below in detail.

[5. During-Pickup Display Processing]

In during-pickup display processing of the present embodiment, when a panoramic image is generated by arranging a plurality of divided images in a predetermined direction and joining them, a guide display for moving the image pickup surface of CCD 1 such that the plurality of divided images are picked up in the above-described predetermined direction is provided. As the guide display, LCD 9 displays a guide (a guide image 102, etc., which will be described later) indicative of the direction in which the image pickup surface of CCD 1 should be moved, and a trajectory (a trajectory 201, etc., which will be described later) indicative of the direction and amount of movement of main body 110 detected by moving-amount detecting unit 5C based on a detection output of acceleration sensor 10. In the present embodiment, a “guide image” is an example of the above-described first information, and a “trajectory” is an example of the above-described second information. FIG. 14 is a flow chart of a subroutine of step S24 (during-pickup display processing) shown in FIG. 13.

Referring to FIG. 14, in during-pickup display processing, at step S240, CPU 5 first causes LCD 9 to display a guide image together with an image picked up by CCD 1, and advances the process to step S241. An example of display screen of LCD 9 at this time is shown in FIG. 5.

Referring to FIG. 5, a screen 904 includes guide images 102 to 104 and guide images 112 to 114. Screen 904 also includes end marks 101, 111.

Guide images 102 to 104 and guide images 112 to 114 represent information indicative of the direction in which main body 110 is to be moved so as to move the image pickup surface of CCD 1 in a direction corresponding to the image pickup direction whose entry has been received at step S21. Screen 904 is a screen when “rightward” has been selected by selection of button 152 on screen 903 (see FIG. 4) as the image pickup direction. Guide images 102 to 104 and guide images 112 to 114 are arrows indicative of the image pickup direction (rightward).

Guide images 102 to 104 have the same length in the lateral direction, and are arranged such that a region in the lateral direction from the left edge of the leftmost guide image 102 to end mark 101 is equally divided into three. Guide images 112 to 114 have the same length in the lateral direction, and are arranged such that a region in the lateral direction from the left edge of the leftmost guide image 112 to end mark 111 is equally divided into three.

Then, at step S241, CPU 5 determines whether or not main body 110 (the image pickup surface of CCD 1) has been moved in the above-described first direction by more than or equal to a predetermined angle during execution of step S243 of previous processing (which will be described later) or after the start of during-pickup display processing. If determined that main body 110 has been moved by more than or equal to the predetermined angle, the process is advanced to step S243, and if determined that main body 110 has not been moved by more than or equal to the predetermined angle, the process is advanced to step S242.

At step S242, CPU 5 determines whether or not main body 110 (the image pickup surface of CCD 1) has been moved in a second direction perpendicular to the above-described first direction by more than or equal to a predetermined distance after the start of during-pickup display processing. If determined that main body 110 has been moved by more than or equal to the predetermined distance, the process is advanced to step S243, and if determined that main body 110 has not been moved by more than or equal to the predetermined distance, the process is advanced to step S241.

At step S243, CPU 5 generates an image indicative of a turning trajectory of main body 110 in accordance with the angle detected at step S241 and/or the direction and distance detected at step 5242, and causes LCD 9 to display that image, thereby updating the guide display. The process is then advanced to step S244.

At step S244, CPU 5 determines whether or not pickup of divided images necessary for generating a panoramic image has been completed. If determined that pickup has not been completed, the process is returned to step 5241, and if determined that pickup has been completed, the process is advanced to step S245.

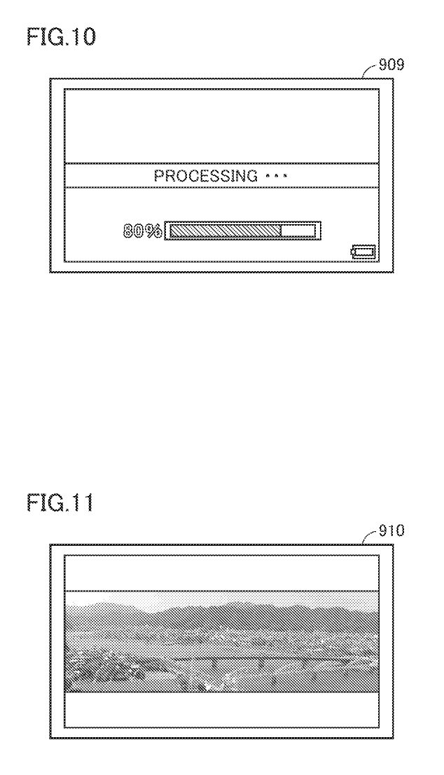

At step S245, CPU 5 causes LCD 9 to display that a panoramic image is being generated, and advances the process to step S246. An example of screen displayed on LCD 9 at this time is shown in FIG. 10. A message reading a panoramic image is being generated is shown on screen 909 of FIG. 10.

At step S246, CPU 5 causes LCD 9 to display the panoramic image generated at step S23, and returns the process to FIG. 13. An example of screen displayed on LCD 9 at this time is shown in FIG. 11. The panoramic image is shown on screen 910 of FIG. 11. It is noted that a panoramic image generated by a plurality of divided images picked up by turning main body 110 in the lateral direction is a laterally-long image as shown in FIG. 11, for example.

[6. Guide Display]

In panoramic during-pickup display processing described above, steps S241 to S243 are continued until pickup of a plurality of divided images is completed. It is noted that, by steps S241 to S243, the guide display on LCD 9 is updated each time main body 110 is moved through a predetermined angle in the first direction, or each time main body 110 is moved by a predetermined distance in the second direction.

The guide display is updated in accordance with progress of pickup of divided images in panoramic image pickup.

Progress of pickup of divided images and update of guide display in panoramic image pickup will be described below.

(Progress of Image Pickup of Divided Images)

In the panoramic image pickup menu, image pickup is performed at a certain time interval, and when main body 110 is turned by a certain angle, pickup of divided images is terminated.

In the present embodiment, an example of the certain angle is 120°. In this case, in the panoramic image pickup menu, pickup of divided images is terminated by turning main body 110 through an angle of 120° as shown in FIG. 32. FIG. 32 shows the state where main body 110 is turned in the direction of an arrow A22 during panoramic image pickup. Arrow A22 represents the above-described first direction. By turning main body 110, the image pickup surface of CCD 1 is turned. In accordance with turning of the image pickup surface of CCD 1, the field of view of CCD 1 is moved. Regions P1 to P3 schematically represent the field of view of CCD 1 at three points of time during panoramic image pickup, respectively.

The field of view of CCD 1 changes from region P1 to region P3 through region P2. FIG. 32 shows the direction of movement of the regions by an arrow A21. Axes T1 to T3 represent the center of the image pickup surface (field of view) of CCD 1 corresponding to regions P1 to P3, respectively. Axes T1 and T3 form an angle of 120° on the horizontal plane. In panoramic image pickup, divided images are picked up until the axis of CCD 1 moves from axis T1 to axis T3. In the following description, in panoramic image pickup, region P1 will be referred to as a starting point of the field of view of CCD 1, and region P3 will be referred to as an endpoint of the field of view of CCD 1.

It is noted that, in panoramic image pickup of the present embodiment, the certain angle is not limited to 120°, but may be more than or less than 120°.

(Update of Guide Display)

In panoramic image pickup processing in the present embodiment, the image pickup surface of CCD 1 is turned through an angle of 120° in the first direction, as described above. Guide images 102 to 104 shown in FIG. 5 each correspond to turning through an angle of 40°. Guide images 112 to 114 also each correspond to turning through an angle of 40° in the above-described turning through an angle of 120°. Guide images 102, 112 correspond to the initial turning through an angle of 40°. Guide images 103, 113 correspond to the next turning through an angle of 40°. Guide images 104, 114 correspond to the last turning through an angle of 40°.

If determined at step S241 that main body 110 has been moved through an angle of 20° in the first direction relative to the position where step S243 in previous processing has been executed, the process is advanced to step S243.

If determined at step S242 that main body 110 has been moved by more than or equal to a predetermined distance in the second direction after the start of during-pickup display processing, the process is advanced to step S243. Herein, the second direction is perpendicular to the first direction, and includes two directions. For example, when the first direction is the direction indicated by arrow A11 as shown in FIG. 28 at (B), the second direction includes two directions, perpendicularly upward (the plus direction along the Y-axis) and perpendicularly downward (the minus direction along the Y-axis). At step S242, when it is detected that main body 110 has been moved in either of the two “second directions” by more than or equal to the predetermined distance, the process is advanced to step S243.

In the present embodiment, a “trajectory” as an example of the above-described second information is displayed as an image of arrow in correspondence to each of guide images 102 to 104 and 112 to 114.

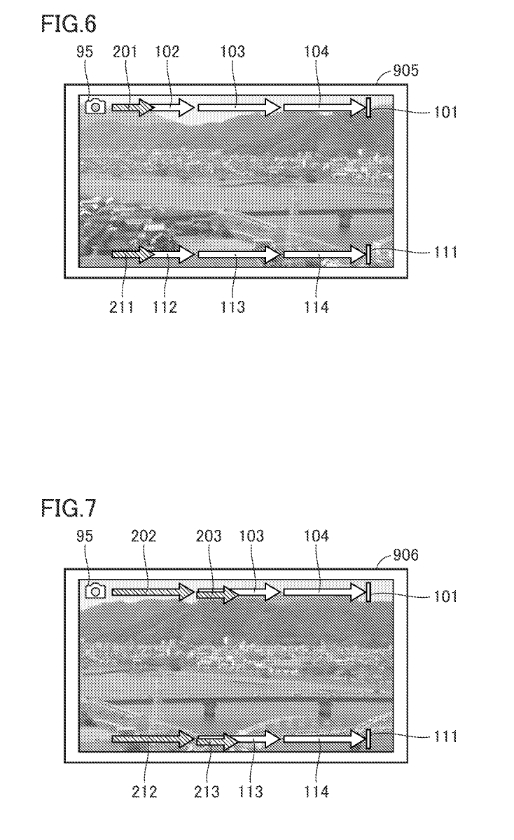

Referring to FIGS. 6 to 9, update of guide display at step S243 will now be described. It is noted that the following description will address the case where “rightward” is designated as the image pickup direction.

FIG. 6 shows an example of screen displayed on LCD 9 when main body 110 has been turned in the first direction through an angle more than or equal to 20° (less than 40°).

Referring to FIG. 6, a screen 905 includes trajectories 201, 211 in addition to guide images 102 to 104 and 112 to 114 displayed on screen 904 of FIG. 5. Trajectories 201, 211 are half the size of guide images 102, 112 in the lateral direction, respectively. The user can thereby identify that main body 110 has been turned in the image pickup direction through half of one-third angle of the whole angle until image pickup is terminated indicated by guide images 102, 112.

FIG. 7 shows an example of screen displayed on LCD 9 when main body 110 has been turned in the first direction through an angle more than or equal to 60° (less than 80°). Referring to FIG. 7, a screen 906 includes trajectories 202, 203 and 212, 213 in addition to guide images 102 to 104 and 112 to 114 displayed on screen 904 of FIG. 5.

Trajectories 203, 213 are displayed as displaced downward from guide images 103, 113, respectively. This is equivalent to that movement of main body 110 by more than or equal to the predetermined distance “perpendicularly downward” of the second directions has been detected during turning of main body 110 in the first direction through turning angles from 40° to 60°.

Trajectories 202, 212 are displayed overlying guide images 102, 112, respectively. This is equivalent to that movement of main body 110 by more than or equal to the predetermined distance in the second directions has not been detected during turning of main body 110 in the first direction through turning angles from 40° to 60°.

FIG. 8 shows an example of screen displayed on LCD 9 when main body 110 has been turned in the first direction through an angle more than or equal to 100° (less than 120°). Referring to FIG. 8, a screen 907 includes trajectories 202, 204, 205 and 212, 214, 215 in addition to guide images 102 to 104 and 112 to 114 displayed on screen 904 of FIG. 5.

Trajectories 204, 214 are displayed as displaced downward from guide images 103, 113, respectively. This is equivalent to that movement of main body 110 by more than or equal to the predetermined distance “perpendicularly downward” of the second directions has been detected during turning of main body 110 in the first direction through turning angles from 40° to 80°.

Trajectories 205, 215 are displayed as displaced upward from guide images 104, 114, respectively. This is equivalent to that movement of main body 110 by more than or equal to the predetermined distance “perpendicularly upward” of the second directions has been detected during turning of main body 110 in the first direction through turning angles from 80° to 100°.

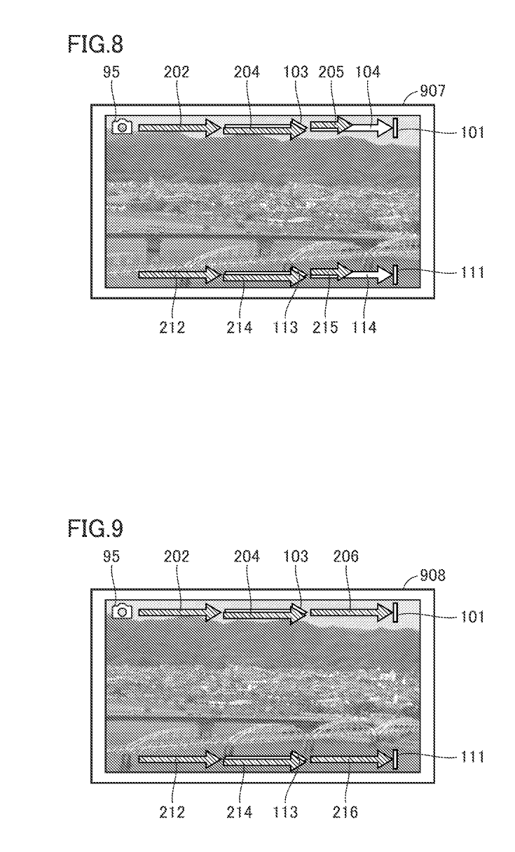

FIG. 9 shows an example of screen displayed on LCD 9 when main body 110 has been turned in the first direction through an angle of 120°. Referring to FIG. 9, a screen 908 includes trajectories 202, 204, 206 and 212, 214, 216 in addition to guide images 102 to 104 and 112 to 114 displayed on screen 904 of FIG. 5.

Trajectories 206, 216 are displayed overlying guide images 104, 114, respectively. This is equivalent to that main body 110 has been moved by more than or equal to the predetermined distance “perpendicularly upward” of the second directions during turning of main body 110 in the first direction through turning angles from 80° to 100° (see FIG. 8), but movement in the second directions by more than or equal to the predetermined distance has not been detected during turning through turning angles from 100° to 120°. That is, this is equivalent to that the trajectory of main body 110 has been corrected into alignment with the image pickup direction.

As described above, the guide display during a period of panoramic image pickup includes guide images 102 to 104, 112 to 114 and trajectories (e.g, trajectories 201, 211). The trajectories are displayed in a mode different from guide images 102 to 104 and 112 to 114 (e.g., in a different color).

In the guide display described above, the lateral length of trajectories (trajectories 201, 211, etc.) is determined depending on the turning angle of the image pickup surface of CCD 1 in the first direction. This is equivalent to that, in FIGS. 6 to 9, the lateral length of a trajectory is one-sixth of the distance from the left edge of guide image 102 to end mark 101 (from the left edge of guide image 112 to end mark 111) when the turning angle ranges from 0° to 20° (FIG. 6), three-sixths (one-half) from 40° to 60° (FIG. 7), five-sixths from 80° to 100° (FIG. 8), and six-sixths from 100° to 120° (FIG. 9). It is noted that, although not shown, the lateral length shall be two-sixths (one-third) when the turning angle ranges from 20° to 40°, and four-sixths from 60° to 80°.

In the present embodiment, the distance from the right edge of a trajectory to each of end marks 101, 111 decreases as the above-described turning angle approaches 120° which is the requirement for terminating pickup of divided images. Therefore, based on this distance, the user can identify the degree of angle through which turning is required until pickup of divided images is terminated.

In the present embodiment, end marks 101, 111 constitute third information indicative of an endpoint of movement in the direction in which the image pickup surface of an image pickup unit should be moved for generating a panoramic image.

In panoramic image pickup, when main body 110 has been moved by more than or equal to the predetermined distance in the second direction, a trajectory is displayed as displaced in the direction indicating the second direction (upward or downward) from each of guide images 102 to 104 and 112 to 114 at a position corresponding to the turning angle when main body 110 has been moved by more than or equal to the predetermined distance in the second direction.

Herein, the moving distance of main body 110 in the second direction is reflected in the amount (distance) by which a trajectory is displayed as displaced from a guide image in the second direction. It is noted that, in the present embodiment, in relation to display of trajectory, three levels of thresholds are assigned for the moving distance in the second direction. FIG. 15 schematically shows the relationship between display of trajectory and moving distance of main body 110 in the second direction. In FIG. 15, the above-described trajectory is indicated by an arrow 9001, and the above-described guide image is indicated by an arrow 9000.

Referring to FIG. 15, when the moving distance of main body 110 in the second direction is less than or equal to a first threshold, the trajectory (arrow 9001) is displayed overlying the guide image (arrow 9000).

When the moving distance of main body 110 in the second direction exceeds the first threshold and is less than or equal to a second threshold larger than the first threshold, the trajectory (arrow 9001) is displayed as displaced from the guide image (arrow 9000) by a first distance in the second direction (upward in FIG. 15).

When the moving distance of main body 110 in the second direction exceeds the second threshold and is less than or equal to a third threshold larger than the second threshold, the trajectory (arrow 9001) is displayed as displaced from the guide image (arrow 9000) by the first distance in the second direction (upward in FIG. 15).

It is noted that, in the present embodiment, when the moving distance of main body 110 in the second direction exceeds the third threshold during panoramic image pickup, the panoramic image pickup menu is discontinued as a panoramic image cannot be generated.

In the present embodiment, as described with reference to FIG. 15, the distance between a guide image and a trajectory indicates how much the direction in which the image pickup surface has been moved is displaced from the direction in which the image pickup surface should be moved. This allows the user of digital camera 100 to easily identify how much the direction of movement of the image pickup surface has been displaced. This allows the user to become aware of avoiding displacements in panoramic image pickup.

In this specification, “the direction in which the image pickup surface has been moved” also means “the position where the image pickup surface has been moved”, and “the direction in which the image pickup surface should be moved” also means “the position where the image pickup surface should be moved.”

[7. Guide Display (2)]

The guide display described above with reference to FIGS. 6 to 9 is provided when “rightward” is selected as the image pickup direction. Herein, a guide display on LCD 9 when “downward” is selected as the image pickup direction will now be described with reference to FIGS. 16 to 21.

A screen 912 of FIG. 16 is displayed as a menu screen, and when button 153 is selected, a screen 913 of FIG. 17 is displayed.

Referring to FIG. 17, screen 913 includes guide images 302 to 304 and guide images 312 to 314. Screen 913 also includes end marks 301, 311.

Guide images 302 to 304 and guide images 312 to 314 represent information indicative of the direction in which main body 110 is to be moved so as to move the image pickup surface of CCD 1 in a direction corresponding to the image pickup direction whose entry has been received at step S21. Guide images 302 to 304 and guide images 312 to 314 are arrows indicative of the image pickup direction (downward).

Guide images 302 to 304 are arranged in descending order of guide images 302, 303, 304. Guide images 302 to 304 each have such a vertical dimension that the distance from the upper edge of guide image 302 to end mark 301 is equally divided into three.

Guide images 312 to 314 are arranged in descending order of guide images 312, 313, 314. Guide images 312 to 314 each have such a vertical dimension that the distance from the upper edge of guide image 312 to end mark 311 is equally divided into three.

FIGS. 18 to 21 are explanatory views of update of guide display at step S243.

FIG. 18 shows an example of screen displayed on LCD 9 when main body 110 has been turned in the first direction (the direction of arrow A 14 shown in FIG. 31 at (B)) through an angle more than or equal to 20° (less than 40°).

Referring to FIG. 18, a screen 914 includes trajectories 401, 411 in addition to guide images 302 to 304 and 312 to 314 displayed on screen 913 of FIG. 17. Trajectories 401, 411 are half the size of guide images 302, 312 in the vertical direction, respectively. The user can thereby identify that main body 110 has been turned in the image pickup direction through half of one-third angle of the whole angle until image pickup is terminated indicated by guide images 302, 312.

FIG. 19 shows an example of screen displayed on LCD 9 when main body 110 has been turned in the first direction through an angle more than or equal to 60° (less than 80°). Referring to FIG. 19, a screen 915 includes trajectories 402, 403 and 412, 413 in addition to guide images 302 to 304 and 312 to 314 displayed on screen 913 of FIG. 17.

Trajectories 403, 413 are displayed as displaced leftward from guide images 403, 413, respectively. In this example, the second direction includes “rightward” (the plus direction along the X-axis in FIG. 31) and “rightward” (the minus direction along the X-axis in FIG. 31). A leftward displacement is equivalent to that movement of main body 110 by more than or equal to a predetermined distance “leftward” of the second directions has been detected during turning of main body 110 in the first direction through turning angles from 40° to 60°.

Trajectories 402, 412 are displayed overlying guide images 302, 312, respectively. This is equivalent to that movement of main body 110 by more than or equal to the predetermined distance in the second directions has not been detected during turning of main body 110 in the first direction through turning angles from 0° to 40°.

FIG. 20 shows an example of screen displayed on LCD 9 when main body 110 has been turned in the first direction through an angle more than or equal to 100° (less than 120°). Referring to FIG. 20, a screen 916 includes trajectories 402, 404, 405 and 412, 414, 415 in addition to guide images 302 to 304 and 312 to 314 displayed on screen 914 of FIG. 17.

Trajectories 404, 414 are displayed as displaced leftward from guide images 403, 413, respectively. This is equivalent to that movement of main body 110 by more than or equal to the predetermined distance “leftward” of the second directions has been detected during turning of main body 110 in the first direction through turning angles from 40° to 80°.

Trajectories 405, 415 are displayed as displaced rightward from guide images 304, 314, respectively. This is equivalent to that movement of main body 110 by more than or equal to the predetermined distance “rightward” of the second directions has been detected during turning of main body 110 in the first direction through turning angles from 80° to 100°.

FIG. 21 shows an example of screen displayed on LCD 9 when main body 110 has been turned through an angle of 120° in the first direction. Referring to FIG. 21, a screen 917 includes trajectories 402, 404, 406 and 412, 414, 416 in addition to guide images 302 to 304 and 312 to 314 displayed on screen 913 of FIG. 17.

Trajectories 406, 416 are displayed overlying guide images 304, 314, respectively. This is equivalent to that main body 110 has been moved by more than or equal to the predetermined distance “rightward” of the second directions during turning of main body 110 in the first direction through turning angles from 80° to 100° (see FIG. 20), but movement by more than or equal to the predetermined distance in the second directions has not been detected during turning through turning angles from 100° to 120°. That is, this is equivalent to that the trajectory of main body 110 has been corrected into alignment with the image pickup direction.

As described above, the guide display in this example includes guide images 302 to 304, 312 to 314 and trajectories (trajectories 401, 411, etc). The trajectories are displayed in a mode different from guide images 302 to 304 and 312 to 314 (e.g., in a different color).

In the guide display described above, the vertical length of a trajectory (trajectories 401, 411, etc.) is determined depending on the turning angle of the image pickup surface of CCD 1 in the first direction. This is equivalent to that, in FIGS. 18 to 21, the vertical length of a trajectory is one-sixth of the distance from the upper edge of guide image 302 to end mark 301 (from the upper edge of guide image 312 to end mark 311) when the turning angle ranges from 0° to 20° (FIG. 18), three-sixths (one-half) from 40° to 60° (FIG. 19), five-sixths from 80° to 100° (FIG. 20), and six-sixths from 100° to 120° (FIG. 21). It is noted that, although not shown, the vertical length shall be two-sixths (one-third) when the turning angle ranges from 20° to 40°, and four-sixths from 60° to 80°.

In this example as well, similarly to the example described with reference to FIGS. 6 to 9, the distance from the lower edge of a trajectory to each of end marks 301, 311 decreases as the above-described turning angle approaches 120° which is the requirement for terminating pickup of divided images. Therefore, based on this distance, the user can identify the degree of angle through which turning of main body 110 (the image pickup surface of CCD 1) is required to be turned until pickup of divided images is terminated.

It is noted that a screen 918 of FIG. 22, for example, is displayed on LCD 9 during a period in which a panoramic image is generated after pickup of divided images is terminated. Screen 918 of FIG. 22 shows a message reading a panoramic image is being generated.

Then, upon completion of generation of a panoramic image, the panoramic image is displayed on LCD 9. An example of screen displayed at this time is shown in FIG. 23. A screen 919 of FIG. 23 displays the panoramic image. It is noted that the panoramic image generated by a plurality of divided images picked up while turning main body 110 (the image pickup surface of CCD 1) in the vertical direction is a vertically-long image as shown in FIG. 23, for example.

[8. Guide Display (3)]

In the present embodiment described above, the guide display includes a guide image for indicating the direction in which main body 110 should be moved in the image pickup direction and a trajectory indicative of the turning angle of main body 110 (the image pickup surface of CCD 1) along that direction.

It is noted that identical two sets of guide image and trajectory described above are displayed. For example, on screen 904 of FIG. 5, guide images 102 to 104 and guide images 112 to 114 display identical information. On screen 905 of FIG. 6, guide images 102 to 104 and guide images 112 to 114 display identical information, and trajectories 201 and 211 display identical information. That is, the guide display in the present embodiment includes two sets of guide displays, one being formed by guide displays provided on one side (upper side) of the screen composed of guide images 102 to 104 and trajectory 201, and the other one being formed by guide displays provided on the other side (lower side) of the screen composed of guide images 112 to 114 and trajectory 211.

It is noted that, in panoramic image pickup, at least one set of guide displays only should be displayed on LCD 9, as shown in FIG. 24.

In panoramic image pickup in this variation, the screen displayed on LCD 9 changes in the order of screen 904 at (A), screen 905 at (B), screen 906 at (C), and screen 907 at (D) in FIG. 24 as main body 110 is turned in the image pickup direction.

On screen 904 of FIG. 24, upper guide images 112 to 114 are not displayed, but only lower guide images 102 to 104 are displayed, as compared with screen 904 of FIG. 5.

On screen 905 of FIG. 24, upper guide images 112 to 114 are not displayed, but only lower guide images 102 to 104 are displayed, while upper trajectory 201 is not displayed, but only lower trajectory 211 is displayed, as compared with screen 905 of FIG. 6.

On screen 906 of FIG. 24, upper guide images 112 to 114 are not displayed, but only lower guide images 102 to 104 are displayed, while upper trajectories 202, 203 are not displayed, but only lower trajectories 212, 213 are displayed, as compared with screen 906 of FIG. 7.

On screen 907 of FIG. 24, upper guide images 112 to 114 are not displayed, but only lower guide images 102 to 104 are displayed, while upper trajectories 202, 204, 205 are not displayed, but only lower trajectories 212, 214, 215 are displayed, as compared with screen 907 of FIG. 8.

[9. Guide Display (4)]

In panoramic image pickup described with reference to FIG. 24, only the lower guide displays are provided, as compared with the guide displays described with reference to FIGS. 5 to 8.

It is noted that, in each panoramic image pickup described with reference to FIGS. 5 to 8 and 24, the guide image is displayed by a plurality of images so as to divide the whole angle through which main body 110 (the image pickup surface of CCD 1) should be turned is divided, as shown by guide images 102 to 104 and guide images 112 to 114.

It is noted that the whole angle through which main body 110 should be turned may be displayed by a single image. The guide display in such a variation will be described with reference to FIG. 25.

In panoramic image pickup in this variation, the screen displayed on LCD 9 changes in the order of a screen 920 at (A), a screen 921 at (B), a screen 922 at (C), and a screen 923 at (D) in FIG. 25 as main body 110 is turned in the image pickup direction.

On screen 920 of FIG. 25, a single guide image 801 is displayed in a region corresponding to guide images 102 to 104, as compared with screen 904 of FIG. 24. The lateral dimension of guide image 801 is equivalent to the sum of the lateral dimensions of guide images 102 to 104.

On screen 921 of FIG. 25, guide image 801 is displayed instead of guide images 112 to 114, and a trajectory 811 is displayed instead of trajectory 211, as compared with screen 905 of FIG. 24. The positional relationship in the vertical direction (perpendicular to the image pickup direction) between guide image 801 and trajectory 811 is identical to that between guide images 112 to 114 and trajectory 211.

On screen 922 of FIG. 25, guide image 801 is displayed instead of guide images 112 to 114, and a trajectory 812 is displayed instead of trajectories 212, 213, as compared with screen 906 of FIG. 24. The positional relationship in the vertical direction (perpendicular to the image pickup direction) between guide image 801 and trajectory 812 is identical to that between guide images 112 to 114 and trajectories 212, 213 (or only the leftmost trajectory 213).

On screen 923 of FIG. 25, guide image 801 is displayed instead of guide images 112 to 114, and a trajectory 813 is displayed instead of trajectories 212, 214, 215, as compared with screen 907 of FIG. 24. The positional relationship in the vertical direction (perpendicular to the image pickup direction) between guide image 801 and trajectory 813 is identical to that between guide images 112 to 114 and trajectories 212, 214, 215 (or only the leftmost trajectory 215).

It is noted that, in the guide display, a portion of guide image 801 in accordance with a turning angle (e.g., a portion overlying trajectory 811 on screen 921 shown in FIG. 25 at (B)) may be displayed in a different mode (color) from another portion for indicating how far the turning of main body 110 (the image pickup surface of CCD 1) has progressed relative to the entire lateral dimension of guide image 801, instead of a trajectory (trajectory 811, etc).

[10. Guide Display (5)]

The guide display in panoramic image pickup described with reference to FIG. 25 may be changed such that identical information is displayed both at the upper and lower sides, similarly to the guide display described with reference to FIGS. 5 to 8. The guide display in such a variation will be described with reference to FIG. 26.

In panoramic image pickup in this variation, the screen displayed on LCD 9 changes in the order of a screen 930 at (A), a screen 931 at (B), a screen 932 at (C), and a screen 933 at (D) in FIG. 26 as main body 110 (the image pickup surface of CCD 1) is turned in the image pickup direction.

On screen 930 of FIG. 26, a guide image 851 indicative of information identical to guide image 801 at the lower side is further displayed at the upper side, as compared with screen 920 of FIG. 25.

On screen 931 of FIG. 26, guide image indicative of information identical to guide image 801 at the lower side and a trajectory 861 indicative of information identical to trajectory 811 at the lower side are further displayed at the upper side, as compared with screen 921 of FIG. 25.

On screen 932 of FIG. 26, guide image 851 indicative of information identical to guide image 801 at the lower side and a trajectory 862 indicative of information identical to trajectory 812 at the lower side are further displayed at the upper side, as compared with screen 922 of FIG. 25.

On screen 933 of FIG. 26, guide image 851 indicative of information identical to guide image 801 at the lower side and a trajectory 863 indicative of information identical to trajectory 813 at the lower side are further displayed at the upper side, as compared with screen 923 of FIG. 25.

It is noted that, in the guide display, a portion of each of guide images 801, 851 in accordance with the turning angle (e.g., portions overlying trajectories 811, 861 on screen 931 shown in FIG. 26 at (B)) may be displayed in a different mode (color) from other portions for indicating how far the turning of main body 110 has progressed relative to the entire lateral dimension of guide images 801, 851, instead of trajectories (trajectories 811, 861, etc).

[11. Variation of Detection Mode of Movement of Image Pickup Surface of CCD]

In the present embodiment described above, the direction of movement of the image pickup surface of CCD 1, that is, the direction and amount of movement of main body 110 are determined based on the detection output of acceleration sensor 10. That is, acceleration sensor 10 and moving-amount detecting unit 5C detecting the direction and amount of movement of main body 110 (the image pickup surface of CCD 1) based on the detection output of that sensor constitute a detection unit.

It is noted that, in digital camera 100, the direction and amount of movement of the image pickup surface of CCD 1 may be detected based on images sequentially picked up by CCD 1, without including acceleration sensor 10. A hardware configuration of digital camera 100 in such a variation is schematically shown in FIG. 33.

Referring to FIG. 33, digital camera 100 in the present variation does not include acceleration sensor 10 (see FIG. 2). CPU 5 includes a moving-amount detecting unit 5D as its function, instead of moving-amount detecting unit 5C (see FIG. 2). This function may be performed by CPU 5 executing a program stored in recording medium 4 or the like, or may be performed as hardware by a dedicated circuit (ASIC (Application Specific Integrated Circuit, etc) in digital camera 100. Moving-amount detecting unit 5D calculates the amount of movement of the coordinate of a specific portion of a plurality of divided images picked up successively (e.g., the left upper point), thereby calculating the direction and amount of movement of the image pickup surface of CCD 1. It is noted that such calculation of the direction and amount of movement is accomplished through use of the principle disclosed in Japanese Patent No. 3545297, for example. More specifically, a plurality of divided images picked up successively are sequentially projected onto a cylindrical surface. Overlapping portions among divided images are detected based on a normalized cross-correlation technique, for example. With the overlapping portions detected, moving-amount detecting unit 5D detects the relative position among the plurality of divided images, thereby detecting the angle of relative arrangement. Moving-amount detecting unit 5D can thereby detect trajectories of movement of divided images from a divided image initially picked up to the latest divided image in panoramic image pickup.

Then, CPU 5 executes steps S241 and S242 (see FIG. 14) using the trajectories of movement of the divided images detected by moving-amount detecting unit 5D as trajectories of movement of main body 110 (the image pickup surface of CCD 1).

That is, in the present variation, the direction (angle) and distance of movement of the divided images successively picked up relative to a divided image initially picked up in panoramic image pickup are detected, and based on them, the display mode of second information (trajectory 201, etc.) is controlled as described with reference to FIGS. 6 to 9 and FIGS. 18 to 21.

In digital camera 100, the direction and amount of movement of the image pickup surface of CCD 1 can be detected with high accuracy by using acceleration sensor 10. On the other hand, in the case of detecting the direction and amount of movement of the image pickup surface of CCD 1 based on image processing of divided images as described with reference to FIG. 33 without using acceleration sensor 10, the detection can be accomplished at low cost by reducing the number of components.

[12. Other Variations, etc.]

According to the present embodiment, when picking up a plurality of divided images for a panoramic image, the user of digital camera 100 can identify the direction in which main body 110 should be moved by display of first information, and by display of second information, can identify the direction in which main body 110 has actually been moved relative to the above-described direction in which main body 110 should be moved. Accordingly, by referring to the first information and second information, the user can identify whether or not main body 110 could have been moved in the direction in which main body 110 should be moved for a panoramic image, and when main body 110 could not have been moved in that direction, the user can identify in which direction main body 110 has been moved relative to the direction in which main body 110 should be moved, without checking the whole finder image displayed on LCD 9.

It is noted that, in the present embodiment described above, designation of the image pickup direction is received in panoramic image pickup, and the first direction and the second direction are determined based on that image pickup direction. It is noted that, in the present embodiment, the image pickup direction is designated by entering a selected one from among the four directions shown in FIG. 4, but it is not limited as such. Options may be of a number other than four. The image pickup direction may be fixed.

The second information can also be regarded as indicating a displacement from the first information in relation to movement of main body 110.

Although, in the present embodiment described above, the plurality of guide images (guide images 102 to 104, etc.) have an identical dimension in the image pickup direction, the guide images should only indicate at least the image pickup direction, and a plurality of guide images having different dimensions may be displayed.

According to the present embodiment described above, since information for guiding movement of the image pickup surface during panoramic image pickup processing and information on the direction and amount that the image pickup surface has been moved are displayed, the user can easily identify the amount of displacement between the direction in which the image pickup surface should be moved and the direction in which the image pickup surface has been moved, based on the amount of displacement from guides on the display.

Accordingly, in the image pickup apparatus, the burden on the user in image pickup for generating a panoramic image can be reduced.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image pickup apparatus comprising:
an image pickup unit having an image pickup surface on which an optical image of a subject is imaged, for executing image pickup processing which generates a frame image based on the optical image; and
a control unit which controls said image pickup unit to execute said image pickup processing repeatedly to cause a display unit to display frame images generated sequentially,
said control unit
executing composite image generation processing which generates a composite image by combining part or whole of each of a plurality of frame images generated when said image pickup unit executes said image pickup processing a plurality of times in relation to movement of said image pickup surface, and
causing said display unit to display first information which guides a direction in which said image pickup surface should be moved during said composite image generation processing and second information which indicates a direction and an amount that said image pickup surface has been moved.

2. The image pickup apparatus according to claim 1, wherein said control unit
causes a first image to be displayed as said first information, said first image having a dimension in the direction in which said image pickup surface should be moved, and
causes a second image to be displayed as said second information, said second image having a dimension in the direction in which said image pickup surface should be moved and being displayed away from said first image in a direction crossing the direction in which said image pickup surface should be moved by a distance corresponding to the amount that said image pickup surface has been moved.

3. The image pickup apparatus according to claim 1, wherein said control unit updates display of said second information at a predetermined time interval.

4. The image pickup apparatus according to claim 1, wherein said control unit causes said first information and said second information to be displayed at a plurality of positions on said display unit.

5. The image pickup apparatus according to claim 1, wherein said control unit causes said display unit to display third information which indicates an endpoint of movement in the direction in which said image pickup surface should be moved for generating said composite image.

6. A method of controlling an image pickup apparatus having an image pickup surface on which an optical image of a subject is imaged, comprising the steps of:
executing image pickup processing which generates a frame image based on the optical image on said image pickup surface;
executing composite image generation processing which generates a composite image by combining part or whole of each of a plurality of frame images generated by execution of said image pickup processing a plurality of times in relation to movement of said image pickup surface; and
causing a display unit to display first information which guides a direction in which said image pickup surface should be moved during said composite image generation processing and second information which indicates a direction and an amount that said image pickup surface has been moved.

7. The method of controlling an image pickup apparatus according to claim 6, wherein
a first image is displayed as said first information, said first image having a dimension in the direction in which said image pickup surface should be moved, and
a second image is displayed as said second information, said second image having a dimension in the direction in which said image pickup surface should be moved and being displayed away from said first image in a direction crossing the direction in which said image pickup surface should be moved by a distance corresponding to the amount that said image pickup surface has been moved.

8. The method of controlling an image pickup apparatus according to claim 6, wherein display of said second information is updated at a predetermined time interval.

9. The method of controlling an image pickup apparatus according to claim 6, wherein said first information and said second information are displayed at a plurality of positions on said display unit.

10. The method of controlling an image pickup apparatus according to claim 6, further comprising the step of causing said display unit to display third information which indicates an endpoint of movement in the direction in which said image pickup surface should be moved for generating said composite image.

11. An image pickup apparatus comprising:
an image pickup unit having an image pickup surface on which an optical image of a subject is imaged, for executing image pickup processing which generates a frame image based on the optical image; and
a control unit which controls said image pickup unit to execute said image pickup processing repeatedly to cause a display unit to display frame images generated sequentially,
said control unit
executing composite image generation processing which generates a composite image by combining part or whole of each of a plurality of frame images generated when said image pickup unit executes said image pickup processing a plurality of times in relation to movement of said image pickup surface, and
causing said display unit to display information which indicates a displacement of a position where said image pickup surface has been moved from a position where said image pickup surface should be moved during said composite image generation processing.
